(19) United States
(12) Patent Application Publication
(10) Pub. No.: US 2004/0028719 A1
(43) Pub. Date: Feb. 12, 2004

(54) Synergistic effect of diet and human interaction on the behavior of dogs

(76) Inventors: Gary Mitchell Davenport, Dayton, OH (US); Michael Barrett Hennessy, Yellow Springs, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/617,629

(22) Filed: Jul. 11, 2003

Related U.S. Application Data
(60) Provisional application No. 60/395,539, filed on Jul. 12, 2002.

(51) Int. Cl. A23K 1/165; A23K 1/17

(52) U.S. Cl. 424/442

(57) ABSTRACT

Disclosed is a method for moderating the behavior of a dog living in an animal shelter wherein said dog is fed a high quality diet, and wherein said dog is optionally provided periodic interaction with a human.

### CROSS REFERENCE TO RELATED APPLICATION

This claims the benefit of U.S. Provisional Application No. 60/395,539, filed Jul. 12, 2002.

### FIELD OF THE INVENTION

The present invention relates to methods of moderating the behavior of a dog living in an animal shelter wherein said dog is fed a high quality diet, and wherein said dog is optionally provided periodic interaction with a human.

### BACKGROUND OF THE INVENTION

Each year in the United States, millions of dogs are confined in public and private animal shelters (Moulton et al., J. Am. Vet. Med. Assoc., Vol. 198, pp. 1172-1176 (1991)). Dogs often arrive at the shelter in a poor physical state due to injury, sickness, or malnutrition.

Animal shelters (including rescue shelters) provide a valuable service by housing stray, released, neglected, and injured animals, and by affording an opportunity for their subsequent adoption. Yet, even modern and well-run shelters present animals with an additional set of stressors or challenges, including confinement, novelty, separation from attachment figures, and a generally unpredictable and uncontrollable environment. Neuroendocrine evidence supports the idea that the shelter environment is stressful: Dogs admitted to a public shelter were found to exhibit protracted activation of the stress-responsive hypothalamic-pituitary-adrenal axis (Hennessy et al., Physiol. Behav., Vol. 62, pp. 485-490 (1997)).

The experience of dogs in shelters is of concern, not only in terms of animal welfare, but also for its potential effects on the behavior of the dog, and therefore for the likelihood of a successful adoption. Confinement in cages has long been associated with the development of behavioral stereotypes in dogs and other species (Fox, Lab. Anim. Care, Vol. 15, pp. 363-370 (1965); Luescher et al., Ad. Companion Animal Behavior. Vet. Clin. North Am. Small Anim. Pract., Vol. 21, pp. 401-413 (1991); Mertens and Unshelm, Anthroz. Vol. 9, pp. 40-50 (1996); Thompson et al., Science, Vol. 123, p. 939 (1956)). Thus, exposure to a shelter can reduce the immediate welfare of the dog, and also may affect the probability of a successful adoption.

The enormous number of dogs euthanized in animal shelters (Moulton et al., J. Am. Vet. Med. Assoc., Vol. 198, 1172-1176 (1991)) and the common failure of dogs from shelters to adapt to adoptive homes (Patronek et al., J. Am. Vet. Med. Assn. Vol. 209, pp. 572-581 (1996); Pet food regulations; In AAFCO official publication, Association of American Feed Control Officials (1999); Salman et al., J. Appl. Anim. Wel. Sci., Vol. 1, pp. 207-226 (1998)) make the welfare and behavioral training of shelter dogs an important consideration.

Correcting acute nutritional deficiencies of dogs admitted to shelters is an important consideration in addressing their welfare. It is unclear whether manipulations of nutrition in diets that meet minimal standards would provide additional benefits. The emotional reactivity and behavior of dogs is thought to be influenced by the specific content of their food, though there appears to be little consensus on the nature of this influence. It has been suggested that increasing the level of dietary protein can calm excitable dogs and improve behavior under stressful circumstances (Ballarini, J. Small Anim. Prac. Vol. 31, pp. 523-532 (1990); Campbell, Behavior Problems in Dogs (Second Ed.), American Veterinary Publications, Inc. (1992)). In contrast, recent studies have suggested a link between high protein diets and aggression in some dogs (Dodman et al., J. Am. Vet. Med. Assoc., Vol. 208, pp. 376-379 (1996); DeNapoli et al., J. Am. Vet. Med. Assoc., Vol. 217, pp. 504-508 (2000)).

The stressors common in animal shelters are known to activate physiological stress systems, particularly the hypothalamic-pituitary-adrenal (HPA) axis, in rodents and other animals, including dogs (Beerda et al., App. Anim. Behav. Sci., Vol. 58, pp. 365-381 (1997); Coover et al., Physiol. Behav., Vol. 6, pp. 261-263 (1971); De Boer, Physiol. Behav., Vol. 45, pp. 789-795 (1989); Friedman et al., Neuroendocrinol., Vol. 2, pp. 209-212 (1967); Hanson et al., Behav. Biol., Vol. 16, pp. 333-340 (1976); Hennessy, Neurosci. Biobehav. Rev., Vol. 21, pp. 11-29 (1997); Muir and Pfister, Physiol. Behav., Vol. 37, pp. 285-288 (1986); Tuber et al., J. Comp. Psychol., Vol. 110, pp. 103-108 (1996)). Dogs have been shown to exhibit plasma cortisol levels during their first three days of confinement in a public animal shelter that are greater than those of either dogs in the shelter for a longer period of time, or pet dogs sampled in their owner's homes (Hennessy et al., Physiol. Behav., Vol. 62, pp. 485-490 (1997)).

What is needed are methods for lowering stress in animals living in shelters. Additionally, what is needed are methods for increasing successful adoption rates and increasing the well being of animals living in shelters. Also needed are methods for decreasing levels of stress hormones in dogs and methods for moderating anxious behavior in dogs.

### SUMMARY OF THE INVENTION

The present invention provides methods for moderating the behavior of a dog living in an animal shelter wherein said dog is fed a high quality diet, and wherein said dog is optionally provided periodic interaction with a human.

The present invention further provides methods of decreasing anxiety in a dog wherein said dog is fed a high quality diet, and wherein said dog is optionally provided periodic interaction with a human.

The present invention also provides methods of increasing the welfare of a dog living in an animal shelter, wherein said dog is fed a high quality diet, and wherein said dog is optionally provided periodic interaction with a human.

Also provided by the present invention are methods of increasing the rate of successful adoption of a dog from an animal shelter, wherein said dog is fed a high quality diet, and wherein said dog is optionally provided periodic interaction with a human.

Additionally provided by the present invention are methods of decreasing ACTH levels in a dog, wherein said dog is fed a high quality diet, and wherein said dog is optionally provided periodic interaction with a human. Methods of improving adaptation of a dog to an animal shelter, wherein the dog is provided a high quality diet, such that the dog's ACTH levels are lower than the ACTH levels of a dog not fed a high quality diet are also provided by the present invention.

The present invention also provides methods of decreasing HPA levels in a dog, wherein said dog is fed a high quality diet, and wherein said dog is optionally provided periodic interaction with a human.

Also provided by the present invention are methods of decreasing cortisol levels in a dog, wherein said dog is fed a high quality diet, and wherein said dog is optionally provided periodic interaction with a human. Further provided by the present invention are methods of decreasing cortisol levels in a dog, wherein the dog is provided periodic interaction with a human, such that the dog's cortisol levels are lower than the cortisol levels of a dog not provided periodic interaction with a human.

The present invention also provides methods for moderating the behavior of a dog living in an animal shelter wherein said dog is fed a high quality diet, wherein said diet contains a high amount of DHA and EPA, and wherein said dog is provided periodic interaction with a human

### BRIEF DESCRIPTION OF THE FIGURES

FIG. 1. Mean daily percentage of the comparison diet (Diet A) and the premium diet (Diet B) consumed by dogs during the 8-week intervention period.

FIG. 2. Mean body weight of dogs fed the two experimental diets on the day prior to the initiation of the intervention period (Day 5) and on the last day of the intervention period (Day 61). Vertical lines indicate the standard errors of the means. Dogs fed the premium diet (Diet B), but not dogs fed the comparison diet (Diet A), gained weight during the intervention period (p<0.01).

FIG. 3. Mean difference scores (post-test—pre-test) for significant effects in the behavioral battery. Vertical lines represent standard errors of the means: (A) Line-crossings during Phase 4, *p<0.05 compared to Diet A; (B) Total escape attempts, *p<0.05 compared to Diet A, Living Room.

FIG. 4. Mean difference scores (post-test—pre-test) for significant effects in the Response to Stranger Test. Vertical lines represent standard errors of the means: (A) seconds panting, *p<0.05 compared to Diet B, No Living Room; (B) number of yawns; (C) number of licks of person, *p<0.05 compared to Diet B, No Living Room, **p<0.01 compared to Diet B, No Living Room; (D) number of nondirected licks, *p<0.05 compared to Living Room.

FIG. 5. Mean plasma cortisol (top) and ACTH (bottom) levels of dogs fed the comparison diet (Diet A) and the premium diet (Diet B) during Weeks 0, 2, 4, and 8 in the shelter. Vertical lines represent standard errors of the means.

FIG. 6. Mean plasma cortisol (top) and ACTH (bottom) levels of dogs fed the comparison diet (Diet A) and the premium diet (Diet B) prior to, and following, the challenge on Weeks 0 and 8 in the shelter. Vertical lines represent standard errors of the means.

FIG. 7. Mean post-challenge cortisol (top) and ACTH (bottom) levels expressed as a percentage of pre-challenge levels for dogs exposed and not exposed to the living room on Weeks 0 and 8 in the shelter. Vertical lines represent standard errors of the means.

### DETAILED DESCRIPTION OF THE INVENTION

The method of the invention is enabled through feeding a high quality diet to a dog. Frequency of administration is not limited. However, the diets are typically administered on an infrequent or as-needed basis or are preferably administered in a more routine manner once, twice, or three times daily. To illustrate, for companion animals, the diet can be provided ad libitum or, for added benefit, as measured portions using feeding guidelines known to those of skill in the art.

As used herein, the term “feeding” (or the like) with regard to a particular diet means to provide the diet to a dog and/or to direct, instruct, or advise the feeding of the diet formulation for a purpose described herein. Wherein the feeding of the diet is directed, instructed or advised, such direction may be that which instructs and/or informs the user (including, for example, the administrator of an animal shelter), that feeding of the diet may and/or will provide one or more of the benefits described herein.

Feeding which is directed may comprise, for example, oral direction (e.g., through oral instruction from, for example, a physician, veterinarian, health professional, sales professional or organization, and/or radio or television media (i.e., advertisement) or written direction (e.g., through written direction from, for example, a physician, veterinarian, or other health professional (e.g., scripts), sales professional or organization (e.g., through, for example, marketing brochures, pamphlets, or other instructive paraphernalia), written media (e.g., internet, electronic mail, or other computer-related media), and/or packaging associated with the diet (e.g., a label present on a package containing the diet). As used herein, “written” includes through words, pictures, symbols, and/or other visible descriptors. Such direction need not utilize the actual words used herein, but rather use of words, pictures, symbols, and the like conveying the same or similar meaning are contemplated within the scope of this invention.

The terms “animal shelter,” “shelter,” or the like as used herein includes humane societies, kennels, pet stores, and other establishments (whether private, publicly funded, or otherwise) that provide temporary housing or refuge for animals (e.g., stray, homeless or abandoned animals) or even permanent housing with respect to facilities which are known as “no-kill” shelters. In addition to providing housing, these shelters may also provide nutrition, and basic and advanced medical care to the animals in the shelter. Animal shelters may provide obedience training, grooming, exercise, and special diets for animals in the shelter. An animal shelter typically houses domesticated animals, but may house other animals as well.

As used herein, the term “behavior modification,” “moderating the behavior” of a referenced dog, or the like includes changes made in the behavior of the dog, including but not limited to, modifications in the dog's sense of well-being; modifications in the dog's anxiety, security, contentment or sociability level; modifications in the amount of panting, licking (both non-specific and specific), pacing, solicitation, or escape attempts; and modifications in the dog's sense of calmness.

As used herein, the term “HPA” refers to hypothalamic-pituitary-adrenal responses.

The term “ACTH” refers to adrenocorticotropic hormone.

The term “DHA” refers to docohexanoic acid.

For purposes of this invention, a “high quality diet” is a diet that provides an allowance or measure of food to sustain the daily dietary and nutritional needs of an average domesticated dog, and provides higher levels of metabolizable energy, animal derived ingredients, protein, fat, DHA, EPA, calories, and better nutrient digestibility, than standard economy diets. High quality diets may optionally be formulated so as to be dry (e.g., in kibble or other form), moist (including semi-moist), or combine both of these forms.

High quality dry diets may optionally contain from about 5% to about 50% crude protein, from about 0.5% to about 25% crude fat, from about 1% to about 10% crude fiber, and from about 1% to about 30% moisture, all by weight of the diet. In a further embodiment of the present invention, a high quality dry diet may contain from about 15% to about 35% crude protein, from about 10% to about 25% crude fat, from about 1% to about 5% crude fiber, and from about 5% to about 20% moisture, all by weight of the diet. In another embodiment of the present invention, a high quality diet is a dry diet that contains a minimum protein level of about 22%, a minimum fat level of about 13%, a minimum moisture level of about 8%, a maximum fiber level of about 3%, a maximum carbohydrate level of about 40%, a minimum level of animal-derived ingredients of about 20%, or a maximum level of cereal-derived ingredients of about 70%, all by weight of the diet. The dry diet may also have a minimum metabolizable energy level of about 3.5 Kcal/g.

High quality moist diets may optionally contain from about 0.5% to about 40% crude protein, from about 0.5% to about 25% crude fat, from about 0.5% to about 15% crude fiber, from about 50% to about 90% moisture, from about 0.1% to about 20% ash, and from about 0.001% to about 5.0% taurine, all by weight of the diet. In another embodiment, high quality moist diets may contain from about 7% to about 35% crude protein, from about 5% to about 25% crude fat, from about 1% to about 5% crude fiber, and from about 70% to about 85% moisture, all by weight of the diet. In another embodiment of the present invention, a high quality diet is a moist diet that contains a minimum protein level of about 9%, a minimum fat level of about 6%, a minimum moisture level of about 60%, a maximum fiber level of about 3%, a maximum carbohydrate level of about 40%, a minimum level of animal-derived ingredients of about 20%, or a maximum level of cereal-derived ingredient of about 70%, all by weight of the diet. The moist diet may also have a minimum metabolizable energy level of about 3.5 Kcal/g.

In one embodiment of the present invention, a high quality diet is a diet, whether dry, moist, or otherwise, that comprises from about 20% to about 50%, alternatively 35% to about 50% of animal-derived ingredients, by weight of the diet. Non-limiting examples of animal-derived ingredients include chicken, beef, pork, lamb, turkey (or other animal) protein or fat, egg, fishmeal, and the like.

In one embodiment of the present invention, a high quality diet is a diet that may contain, but is not limited to, a component selected from the group consisting of chicken, ground corn, poultry fat, grain sorghum, brewers rice, fish meal, beet pulp, flavor digest, dried egg, dicalcium phosphate, potassium chloride, brewer's yeast, ground flax, sodium chloride, menhaden oil, and mixtures thereof. In a further embodiment, the diet contains two or more, three or more, four or more, or five or more of these components.

In one embodiment of the present invention, a high quality diet is a diet wherein the DHA level is at least about 0.05%, alternatively at least about 0.1%, alternatively at least about 0.15% of the diet, all by weight of the diet. In another embodiment of the present invention, a high quality diet is a diet wherein the DHA level is from about 0.05% to about 0.25% of the diet, by weight of the diet. In another embodiment of the present invention, a high quality diet is a diet wherein the DHA level is from about 0.07% to about 0.18% of the diet, by weight of the diet.

In one embodiment of the present invention, a high quality diet is a diet wherein the EPA level is at least about 0.05%, alternatively at least about 0.1%, alternatively at least about 0.15% of the diet, all by weight of the diet. In another embodiment of the present invention, a high quality diet is a diet wherein the EPA level is from about 0.05% to about 0.25% of the diet, by weight of the diet. In another embodiment of the present invention, a high quality diet is a diet wherein the EPA level is from about 0.07% to about 0.15% of the diet, by weight of the diet.

Non-limiting examples of high quality diets within this invention include, but are not limited to EUKANUBA® Premium Performance Formula, EUKANUBA® Large Breed Puppy Formula, EUKANUBA® Adult Maintenance, EUKANUBA® Lamb and Rice Adult Dog Formula, EUKANUBA® Large Breed Formula for Adult Dogs, EUKANUBA® Puppy Formula, EUKANUBA® Reduced Fat Formula, EUKANUBA® Senior Maintenance, EUKANUBA® Senior Large Breed Maintenance Formula, EUKANUBA® Senior Large Breed Dog, EUKANUBA® Senior Maintenance Formula Dog Food, EUKANUBA® Adult Maintenance and Adult Small Bite, EUKANUBA® Adult Lamb and Rice Formula Dog Food, EUKANUBA® Puppy Lamb and Rice Formula, EUKANUBA® Large Breed Adult Reduced Fat, EUKANUBA® Puppy Medium Breed Formula, EUKANUBA® Adult Reduced Fat Formula Dog Food, EUKANUBA® Small Breed Adult, EUKANUBA® Puppy Small Breed Formula Dog Food, and other nutrient-dense diets which are commercially available.

### EXAMPLES

In this study, we examined dogs in a public animal shelter over an 8-week period. We examined the effect of diet and human interaction on the dogs. We also examined the independent and combined effects of two interventions, one behavioral and one nutritional, on hypothalamic-pituitary-adrenal (HPA) activity of the dogs.

The behavioral intervention was a twenty minute session of human interaction occurring 5 days each week. This intervention was chosen based on previous experience suggesting that manipulations of this sort can calm dogs in a shelter environment (Tuber et al., Psychol. Sci., Vol. 10, pp. 379-386 (1999)), and on the earlier finding that soothing tactile contact immediately following venipuncture reduces the plasma cortisol elevation to this mild stressor (Hennessy et al., Appl. Anim. Behav. Sci., Vol. 61, pp. 63-77 (1998)). See also, for example, the behavior modification procedures described in the following: Voith, V. L., Applied Animal Behavior for the Veterinary Practitioner, American Animal Hospital Association's 47^{th} Annual Meeting Proceedings (1980); Voith, V. L., Coming When Called and the Sit-Stay, Methods 3 (2), pp 13-20 (1980); Voith V. L., Teaching the Sit-Stay, Modern Veterinary Practice 63 (4) (April 1982); Voith V. L., Teaching the Down-Stay, Modern Veterinary Practice 63 (5) (May 1984); Voith V. L. and Spiegel D. Door Exercises, Animal Behavior and the Veterinarian, 1997-1998 Small Animal Seminar,_The_Michigan Veterinary Medical Association, pp 50-74 (1997); Marder, A. M. DO-IT-YOURSELF SIT-STAY, Voith V L and Borchelt B L (Eds): Readings in Companion Animal Behavior, Veterinary Learning Systems, Trenton N.J., pp.59-60; Voith, V L., The Sit-Stay Program, Down-Stay Exercises, Coming Exercises, and Relinquishment of Objects Exercises, Door Exercises, Applied Animal Behavior Consultants Client Handouts (1977-1998).

To assess the effect of diet quality on behavior and HPA in the present study, dogs in a public animal shelter were fed one of two experimental diets that differed in ingredients, nutritional content, and digestibility. Although both met minimal nutritional standards, one was a high quality diet as defined herein (in this example, the diet was formulated to provide higher levels of digestible protein, fat, DHA, EPA, beet pulp and calories, as well as a higher percentage of animal derived ingredients), while the other diet was not. In addition to possible main effects of diet or of human contact on behavior, possible statistical interactions were examined. It was reasoned that if diet were to have a calming effect on dogs, that it may act by affecting the way in which they responded to human contact.

All dogs were tested in a behavioral battery that assessed responses to novel or startling situations as well as in a second test that focused on the dog's responses to an unfamiliar human. Both tests were administered prior to the initiation of interventions (pre-test), as well at the end of the intervention period (post-test). This allowed the actual change due to the intervention to be evaluated. For those dogs exposed to the behavioral intervention, the effectiveness of the training administered during the intervention, and any effect of diet on the effectiveness of training, were investigated.

Plasma levels of the adrenal hormone, cortisol, and its tropic pituitary hormone, ACTH were examined. To assess the effect of the interventions on HPA activity in the shelter environment, circulating levels of cortisol and ACTH were examined at Week 0 (after admittance to the shelter, but prior to initiation of interventions), as well as 2, 4 and 8 weeks later. The cortisol and ACTH responses to an additional challenge were investigated at Weeks 0 and 8.

Method

Subject Selection and Assignment. The subjects were 20 male and 20 female dogs admitted to the Montgomery County Animal Shelter in Dayton, Ohio. In order to be eligible for the study, a dog had to be judged to be in good health by a shelter veterinarian. Further, the dog had to be judged to be a suitable candidate for adoption once the study had ended. This latter judgment was based largely on observations of the behavior of the dog by shelter staff and experimenters. Dogs that exhibited aggression or extreme timidity were not entered into the study. The pool of potential subjects included strays, dogs brought in by previous owners for various reasons, and dogs seized by shelter staff because of neglect or other violations. Both intact and gonadectomized males and females (non-lactating) were included. Thus, the sample approximated the population of dogs commonly available at shelters. To restrict the age range of subjects, dogs less than 6 months of age as judged by inspection of dentition were excluded from the study. Because of the difficulty of documenting the source of many dogs brought to the shelter, no attempt was made to distinguish subjects on the basis of provenance.

Upon admission to the shelter, eligible dogs were assigned to one of four experimental groups defined by the factorial combination of two levels of human interaction (low and high) and two diets (Diet A and Diet B). Assignment was made in a quasi-random fashion with the following restrictions. Each experimental group had to consist of five males and five females, and the average weight of dogs assigned to the four groups had to be roughly equivalent. Further, in order to provide some estimate of, and balance in, the phenotype of dogs assigned to the experimental groups, a trained observer judged which of the seven American Kennel Association breed groups each dog best fit. This judgment represented a forced choice procedure since many of the dogs possessed characteristics of more than one breed group. To the extent possible given the other restrictions, dogs judged to be of the same breed group were distributed across experimental groups. Table 1 displays the judged breed groups of subjects in each of the experimental groups.

TABLE 1
Number of Dogs Judged to be in Various Breed Groups
In Each Experimental Condition

| | Experimental Condition | | | |
|---|---|---|---|---|
| | | No Living | | |
| | No Living Room | Room | Living Room | Living Room |
| Breed Group | Diet A | Diet B | Diet A | Diet B |
| Herding | 1 | 2 | 2 | 2 |
| Hounds | 3 | 2 | 4 | 3 |
| Non-sporting | 1 | 2 | 1 | 2 |
| Sporting | 2 | 2 | 2 | 1 |
| Terriers | 2 | 1 | 1 | 1 |
| Toys | 0 | 0 | 0 | 0 |
| Working | 1 | 1 | 0 | 1 |
| Total | 10 | 10 | 10 | 10 |

During the course of the study, dogs were maintained in a dedicated room that contained a bank of metal cages of various sizes (0.6-0.9×0.7×0.6-0.7 m) as well as two larger pens (1.5×0.8×1.9 m). Dogs were kept in cages or pens according to body size. The room was illuminated during daylight hours by a combination of artificial and natural lighting.

Interventions

Experimental interventions were initiated on the dog's sixth day in the shelter. The first 5 days are designated Week 0; Day 6 therefore marks the beginning of Week 1 of the 8-week intervention period.

The behavioral intervention utilized in this example, which included periodic interaction with a human (herein referred to as the “living room”) occurred in a small room (about 7.1 m²) located about 19.5 m from the housing area in the shelter. The room was intended to simulate rooms to which the dogs were likely accustomed prior to admission to the shelter and to which the dogs might be exposed following adoption. The room contained a desk and chair. Light was provided by a desk lamp as well as by overhead fluorescent fixtures. The room was carpeted and also contained a small rug. The room adjoined the public waiting room, and so was buffered from the noise of the animal housing area. Five days each week, the designated dogs were brought individually to the living room by trained handlers for about twenty minutes during the afternoon. Each dog was exposed to the same handler for at least about 70% of its living room sessions. In each of the two diet conditions, six dogs were exposed predominantly to a male handler and four dogs were exposed primarily to a female.

During the first 3 minutes in the living room, the dog was allowed to freely explore. For the next 10 minutes, the dog was gently and slowly stroked and massaged while spoken to in a soothing manner (Hennessy et al., Appl. Anim. Behav. Sci. 61, 63-77 (1998); Tuber, D. S., Anim. Behav. Consult. Newslet. 3, 2 (1986)). At this time, the dog was encouraged to lie quietly on the small rug. For the last 7 minutes, the dog was reinforced with food reward in an escalated appetitive training regime. Training began with simple tasks (e.g., come, sit) and progressed through more difficult exercises (e.g., remain seated while the human left and re-entered the room). During each training session, one half of a hot dog (KAHN's beef franks) sliced into small pieces was used as positive reinforcement. The diet of dogs not exposed to the living room was supplemented with a half of hot dog five days each week. These hot dogs were the only supplement provided to the assigned diets.

All dogs in the study were given a 10 minute outdoor walk on a lead, 5 days per week, for the duration of the study. Experimenters and shelter staff were instructed to minimize interaction with the dogs during walks, feeding and cage cleaning. Nonetheless, the dogs in the two human interaction groups all received modest human interaction during these procedures, and differed only in whether or not they were exposed to the living room.

Beginning on their sixth day in the shelter, dogs were provided with one of two experimental diets (Diets A and B). The diet that dogs were fed prior to Day 6 varied based upon the diet being fed by the animal shelter at that time, but was never one of the experimental diets. The major ingredients contained in the diets are shown in Table 2. Table 3 displays the nutrient content and digestibility coefficients of each diet. The nutrient content of each diet reflects results from laboratory analyses conducted on representative samples of each diet using procedures established by the Association of Official Analytical Chemists (Official Methods of Analysis, Ed. 14. Association of Official Analytical Chemists, (1984)). The nutrient digestibility coefficients were determined by feeding these diets to a second panel of dogs and quantitatively collecting fecal and urinary excreta for nutrient analysis using AOAC procedures. The diets were formulated to mimic commercially available diets and to correspond to industry categories of “popular” (Diet A) and “premium” (Diet B; Case et al., Canine and Feline Nutrition: a Resource for Companion Animal Professionals (Second Ed.), Mosby, St. Louis, Mo. (2000)). Both diets met or exceeded daily minimum nutrient requirements established by the American Association of Feed Control Officials (1999), and were capable of fulfilling the basic nutritional needs of the animal while avoiding any overt nutritional deficiencies. However, Diet B provided greater nutritional quality than did the comparison diet (Diet A) in terms of digestibility, percentage of animal-derived ingredients, and metabolizable energy. Diet B also furnished higher overall levels of protein, fat, DHA, EPA, and beet pulp.

All experimenters and shelter staff were blinded as to the identity of the two diets. The amount of diet offered to each dog was calculated to maintain body weight and condition based on the National Research Council recommendation for estimating daily metabolizable energy requirements (National Research Council, 1985). Dogs that were obviously underweight upon entry to the study were fed rations suitable for their estimated ideal weight. At the time of feeding, the amount of food remaining in the food bowl from the previous day was measured and recorded. Measures of consumption of the diet and weight gain are reported in the Results section, hereinbelow. Dogs were weighed each Friday for the monitoring of health and the determination of ration size for the following week. Because dogs entered the study on different days of the week, these dates of weighing did not correspond to specific days relative to the start of the study. For purposes of analysis of weight change during the study, we utilized weights obtained on Day 5 (the last day of Week 0) and Day 61 (the last day of Week 8).

TABLE 2
Major Ingredients (in Descending Order) of Experimental Diets

| Diet A | Diet B |
|---|---|
| Ground corn | Chicken |
| Meat and bone meal | Ground corn |
| Wheat flour | Poultry fat |
| Soybean meal | Grain sorghum |
| Wheat midds | Brewers Rice |
| Corn gluten meal | Fish meal |
| Animal fat | Beet pulp |
| Flavor digest | Flavor digest |
| Sodium chloride | Dried egg |
| Calcium carbonate | Dicalcium phosphate |
| Dicalcium phosphate | Potassium chloride |
| Vitamins | Brewer's yeast |
| Minerals | Ground flax |
| | Sodium chloride |
| | Menhaden oil |
| | Magnesium sulfate |
| | Choline chloride |
| | Calcium carbonate |
| | DL-methionine |
| | Vitamins |
| | Minerals |

TABLE 3
Nutrient Content and Digestibility of Experimental Diets

| | | Diet B (high |
|---|---|---|
| Nutrient | Diet A | quality diet) |
| EPA (%) | 0.02 | 0.13 |
| DHA (%) | 0.03 | 0.18 |
| Protein (%) | 23.0 | 29.9 |
| Fat (%) | 10.1 | 20.5 |
| Moisture (%) | 7.5 | 8.0 |
| Crude Fiber (%) | 3.2 | 1.9 |
| Carbohydrate (%) | 47.2 | 32.2 |
| Ash (%) | 9.0 | 8.0 |
| Calcium (%) | 1.4 | 1.0 |
| Phosphorus (%) | 1.1 | 1.0 |
| Metabolizeable energy (Kcal/g) | 3.3 | 3.9 |
| Animal Derived Ingredients (%) | 25.7 | 53.6 |
| Cereal Derived Ingredients (%) | 72.8 | 36.6 |
| Digestibility (%) | | |
| Dry Matter* | 85.4 | 90.3 |
| Organic Matter* | 88.5 | 92.8 |
| Protein* | 88.4 | 94.0 |
| Fat* | 89.4 | 94.5 |
| Carbohydrate | 90.5 | 91.2 |
| Digestible Energy* | 88.6 | 93.5 |
| Metabolizeable Energy* | 84.9 | 90.3 |

*p < 0.001 for Diet A vs Diet B by t-test in panel of dogs used to determine digestibility

Behavioral Test Procedures

Behavioral Battery. A behavioral battery, which was nearly identical to that described in a previous study (Hennessy et al., Appl. Anim. Behav. Sci., Vol. 73, pp. 217-233 (2001)), was used to assess reactions to threatening or novel circumstances. The battery was administered on Day 3 (Week 0, pre-test), and Day 60 (Week 8, post-test), and was conducted in a wooden building located in close proximity to the shelter. Two 1.6-m high walls were joined to two inside walls of the building to create a 5.5×5.7 m test arena. In one corner of the arena was an observation blind, with 2, 0.5 m² viewing areas located 1.8 m above the floor of the arena. The concrete floor of the arena was marked off with lines of tape 0.9 m apart to form squares for estimating locomotor activity.

The test battery was divided into four phases (Table 4). The first phase assessed the initial reaction of being placed alone into the novel test arena. Phase 2 was concerned with the dog's reaction to an unfamiliar person in this environment. Phases 3 and 4 addressed how the dog would respond to startling stimuli in the novel environment. All behaviors scored during the four phases, and their definitions, are presented in Table 5. Behaviors scored during each phase were determined by the focus of the phase and the restriction that the behaviors had to be accurately scored by a single observer.

TABLE 4
The Four Phases of the Behavioral Battery

| Phase | Description |
|---|---|
| 1 | Dog alone in arena for 2 minutes |
| 2 | Unfamiliar woman motionless in arena for 2 minutes; |
| | walks around perimeter of arena for 1 minute |
| 3 | Preceded by 30 seconds of remote-controlled car approaching dog; |
| | Dog alone in arena (car stationary) for 2 minutes |
| 4 | Proceeded by blast of airhorn; Dog alone in arena for 2 minutes |

TABLE 5
Behaviors Observed in the Battery, their Definitions,
phases in which they were observed and
Associated Behavior Factors

| Behavioral | | Phases | |
|---|---|---|---|
| Measure | Brief Definition | Observed | Factor |
| Line-Crossing | Number of times all 4 feet cross line | 1, 3, 4 | Locomotor |
| | on floor | | activity |
| Escape | Number of bouts of movement | 1, 3, 4 | Flight |
| | suggesting intent to jump or climb | | |
| | over, dig under, or squeeze or break | | |
| | through walls or door of arena | | |
| Jump | Number of times dog completely | 1 | Flight |
| | leaves ground or rears up on hind legs | | |
| | other than apparent attempts at escape | | |
| Vocalization | Number of discreet vocalizations | 1 | Solicitation |
| Latency to contact | Number of seconds until dog makes | 2 | Solicitation |
| person | physical contact with handler standing | | (reverse |
| | in center of arena (no contact scored | | scored) |
| | 120 seconds) | | |
| Stranger contact | Number of seconds in physical contact | 2 | Sociability |
| | with stranger (scored by stranger) | | |
| Stranger proximity, | Number of seconds within one square | 2 | Sociability |
| stationary | (created by lines on floor) of stranger | | |
| | while stranger is stationary | | |
| Stranger proximity, | Number of seconds within one square | 2 | Sociability |
| walk | of stranger while stranger walks about | | |
| | perimeter of arena | | |
| In far corners | Number of seconds that dog is in | 3, 4 | Timidity |
| | corners farthest from the car or horn (3 | | |
| | corners: intersection of observation | | |
| | blind with far wall and perpendicular | | |
| | wall; intersection of far wall with other | | |
| | perpendicular wall) | | |
| Latency to contact | Number of seconds from cessation of | 3 | Wariness |
| car | car's movement until dog makes | | |
| | contact with car (no contact scored as | | |
| | 120 seconds) | | |
| Latency to approach | Number of seconds from horn blast | 4 | Wariness |
| horn | until dog enters 0.5 m radius semi- | | |
| | circle centered about aperture in wall | | |
| | through which horn blast is projected | | |
| | (no approach scored as 120 seconds) | | |
| Approach | Number of movements in direction of | 3, 4 | Locomotor |
| | car (following cessation of car | | activity |
| | movement) or horn (following | | |
| | sounding of horn) | | |
| Withdrawal | Number of movements in direction | 3, 4 | Locomotor |
| | opposite car (following cessation of | | activity |
| | car movement) or horn (following | | |
| | sounding of horn) | | |

Testing occurred at the conclusion of the dog's scheduled 10 minute walk. The person walking the dog brought it into the building and to the gate of the arena. The lead was then removed, and the dog was placed into the arena, where it was observed for 2 minutes (Phase 1). To begin Phase 2, a woman who was unfamiliar to the dog entered through the gate and walked slowly to the middle of the arena where she stood for 2 minutes. At the end of the 2 minute period, the woman walked slowly to a point in front of the gate, and then around the entire perimeter of the arena (total walking time was 1 minute) before exiting through the gate. Women serving as strangers in this and the Response to Stranger Test (below) never interacted with the dog at other times. Following Phase 2, the observer activated a remote-controlled toy car located in one corner of the arena and moved it in the direction of the dog. If the dog did not retreat, the car was made to approach the dog repeatedly. No attempt was made to contact the dog with the car. After 30 seconds of movement, the car was sent back to its starting location, and the dog was observed for 2 minutes (Phase 3). To begin Phase 4, an airhorn was sounded through a small hole located near the floor, midway along one long wall of the arena. Behavior was recorded during the next 2 minutes. After each test, any feces were removed, and a mop and detergent were used to remove traces of feces or urine.

Response to Stranger Test.

To more completely assess the dog's response to an unfamiliar human, each dog was examined for 10 minutes with an unfamiliar female on Day 4 (Week 0, pre-test) and on Day 61 (Week 8, post-test). Following a 10-minute walk, testing took place in a portion of the arena was used for the behavioral battery. The two ends of a length of chain fencing were attached to intersecting walls of the arena to form a 6.5 m² test area. The woman sat quietly on a stool in a corner of this area. The dog was taken off its lead and placed into the test area. The stranger was instructed to slowly pet the dog when it was within arm's reach. If the dog jumped on the stranger, she was instructed to say “down” and to gently push the dog back to the floor.

The observer, located in the blind, recorded the number of seconds that the dog panted and the number of times it yawned and licked (scored separately for licking self, the stranger, inanimate objects, and nondirected licking). The stranger used a stopwatch to score the number of seconds in physical contact with the dog (other than the petting hand). In addition, an overhead video camera (Camera: Panasonic WV-BP310 with Panasonic lens WV-LA210C3; VCR: Panasonic AG-7350) recorded the test session. The tapes were scored to determine the number of seconds spent in contact/proximity to the person (within one square; a measure of solicitation of human contact), walking (to assess locomotor activity/exploration), or lying down (a measure of calmness or relaxation).

Assessment of Endocrine Levels

Circulating levels of cortisol and ACTH were assessed on Days 3 (Week 0, pre-test), 19 (Week 2), 33 (Week 4), and 60 (Week 8). In conjunction with the assessments on Days 3 and 60, we examined each dog's response to an additional challenge. On these occasions, the dog was removed from its cage and the blood sample to estimate circulating hormone levels in the shelter was collected within 4 minutes. Then the dog was put on lead and given its 10-minute walk. This walk terminated at a wooden building located in close proximity to the shelter. The dog was ushered into a 5.5×5.7 m test arena with concrete floor and wooden walls that was constructed within the building. The dog then underwent a test battery. See e.g., Hennessy et al., Appl. Anim. Behav. Sci. 73, 217-233 (2001); Hennessy et al., J. Am. Vet. Med. Assoc., Vol. 221, No. 1 (Jul. 1, 2002); and Hennessy et al., Journal of Applied Animal Welfare Science, Vol. 5(4), pp. 253-273 (2002). Briefly, the battery was divided into four phases. In Phase 1 (2 minutes), the dog was alone and not exposed to additional stimulation. In Phase 2 (3 minutes), a person who was unfamiliar to the dog was present in the arena, but did not interact with the dog. Following Phase 2, the person left, and for the next 30 seconds, a remote-controlled toy car was made to repeatedly approach the dog. During Phase 3 (2 minutes), the dog remained in the arena with the now stationary toy car. The beginning of Phase 4 was signaled with the blast of an airhorn and consisted of the dog remaining alone in the arena for an additional 2 minutes. Immediately following the conclusion of the test battery, a second blood sample was collected.

Blood samples (about 1 mL) were obtained with injection needle and syringe from the cephalic vein. One individual held the dog so that a second could collect the sample. Blood was rapidly transferred from the syringe to two separate tubes, each containing a different anticoagulant: heparin for analysis of cortisol, and EDTA for analysis of ACTH. Blood samples were always collected within 4 minutes from the beginning of disturbance, and usually within about 2 minutes (M=137 +/−4 seconds). The samples were placed on ice, and plasma was then separated in a refrigerated centrifuge and frozen until analysis. Samples to be analyzed for ACTH were stored at −80 C. Samples were assayed in duplicate using standard ¹²⁵I radioimmunoassay kits (cortisol: Diagnostic Products Corporation, Coat-a-Count; ACTH: ICN Biomedical). Sixteen samples designated for ACTH analysis (two male and two female samples in each group) were lost due to error. Intra-assay coefficients of variation were 7.6% for cortisol and 20.9% for ACTH. For inter-assay variability, these figures were 18.0% and 9.6%, respectively.

Data Analysis

Duncan Multiple Range tests were used for multiple paired comparisons. Pearson Product Moment Correlation Coefficients were used to assess the possible relation between sampling time and endocrine levels. For these correlations, a 1-tailed probability value of 0.05 was considered significant. For all other comparisons, a 2-tailed probability value of 0.05 was employed. Significant interactions were further analyzed with tests for simple main effects (Winer, Statistical Principles in Experimental Design (2^{nd} ed), McGraw-Hill, New York, N.Y. (1971)).

To focus on changes in measures during the intervention period analysis of behavior in the behavioral battery and response to stranger test were based on difference scores (post-test, Week 8 minus pre-test, Week 0). A 2-tailed probability value of 0.05 was considered to be significant throughout.

Results

Diet Consumption, Body Weight, and Training

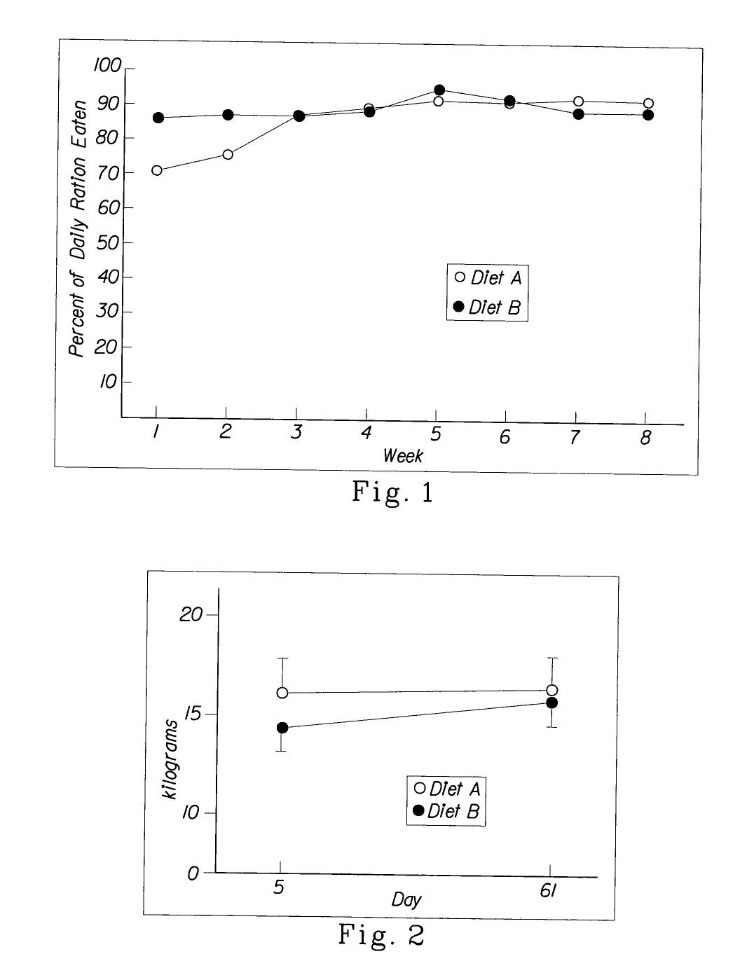

The percentage of diet eaten averaged across weeks is illustrated in FIG. 1. Data were subjected to arcsine transformation prior to analysis. Although there was a tendency for dogs to consume a greater percentage of Diet B than Diet A during the first 2 weeks in the study, a 3-way ANOVA (No Living Room/Living Room×Diet×Weeks, with the last factor treated as a repeated measure) yielded only a significant effect of Weeks, F (5, 162)=4.64, p=0.001), reflecting greater consumption as the study proceeded.

Dogs generally gained weight during their stay in the shelter, particularly if they were given the premium diet, Diet B. Whereas 13 of 20 dogs (65%) provided Diet A gained weight, 18 of 20 dogs (90%) given Diet B did so. A differential effect of diet on weight gain was confirmed in ANOVA by a significant interaction of Diet×Weeks, F (1, 36)=7.37, p=0.01; FIG. 2). Tests for simple main effects showed that there was a significant increase in weight across the treatment period for dogs given Diet B (p<0.01), but not for dogs given Diet A.

Overall, the dogs readily learned new tasks in the Living Room. However, there was no difference in final level of training achieved by dogs fed the two diets (t (18)=1.06, p>0.10).

Behavioral Battery

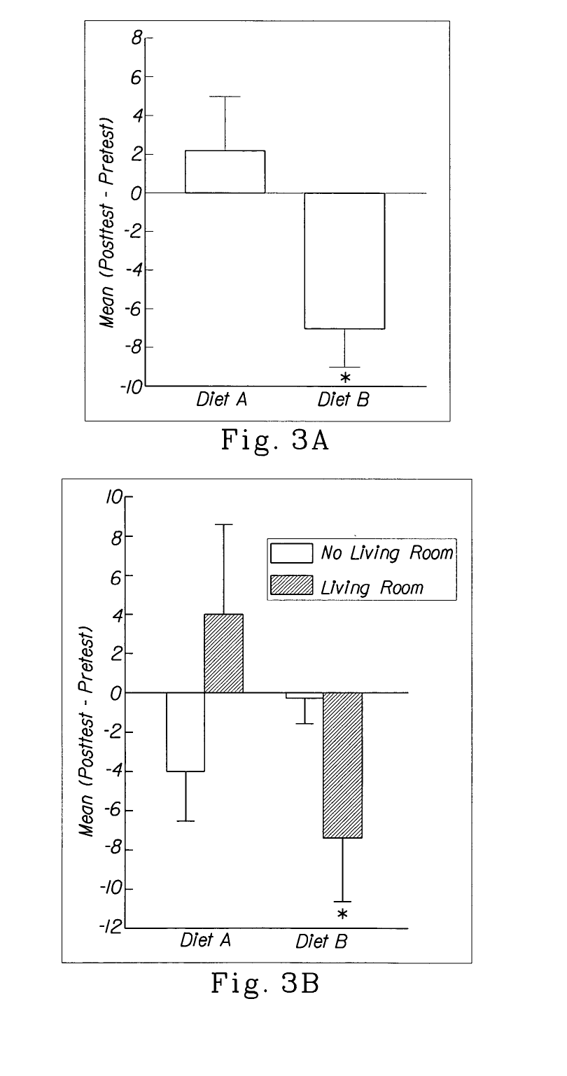

Analyses of individual measures in the behavioral battery resulted in one significant effect: a main effect of diet on activity in Phase 4, F (1, 36)=6.87, p=0.013. As seen in FIG. 3, locomotor activity in Phase 4 diminished across the study for those dogs given Diet B, but not for those dogs given Diet A.

The following derived measures were also analyzed: suppression of locomotion in Phases 3 and 4 (line-crossings Phase 1 minus line-crossings Phase 3; line-crossings Phase 1 minus line-crossings Phase 4), total line-crossings, and total escape attempts (sum of line-crossings or escape attempts, respectively, during the three phases—1, 3, and 4—in which line-crossings and escape attempts were assessed). These analyses revealed a significant No Living Room/Living Room×Diet interaction for escape attempts, F (1, 36)=5.47, p=0.025. A test for simple main effects for dogs exposed to the living room was significant (p<0.05). In this group, those dogs fed Diet B showed a relative reduction in escape attempts during the course of the study as compared to dogs fed Diet A (FIG. 3). There was no significant effect of diet for those dogs not exposed to the living room.

Also assessed was the effect of the living room and diet on five factors (Locomotor Activity, Flight, Sociability, Timidity, and Wariness) (Hennessy et al., Appl. Anim. Behav. Sci., Vol. 73, pp. 217-233 (2001)), and the effects were computed by combining z scores of individual measures. For these factors, the only effect of significance was a tendency for Diet B to reduce Locomotor Activity [sum of z scores for line-crossings Phase 1+line-crossings Phase 3+line-crossings Phase 4+approaches Phase 3+approaches Phase 4+withdrawals Phase 3+withdrawals Phase 4, F (1,36)=3.41, p=0.073.]

Response to Stranger Test

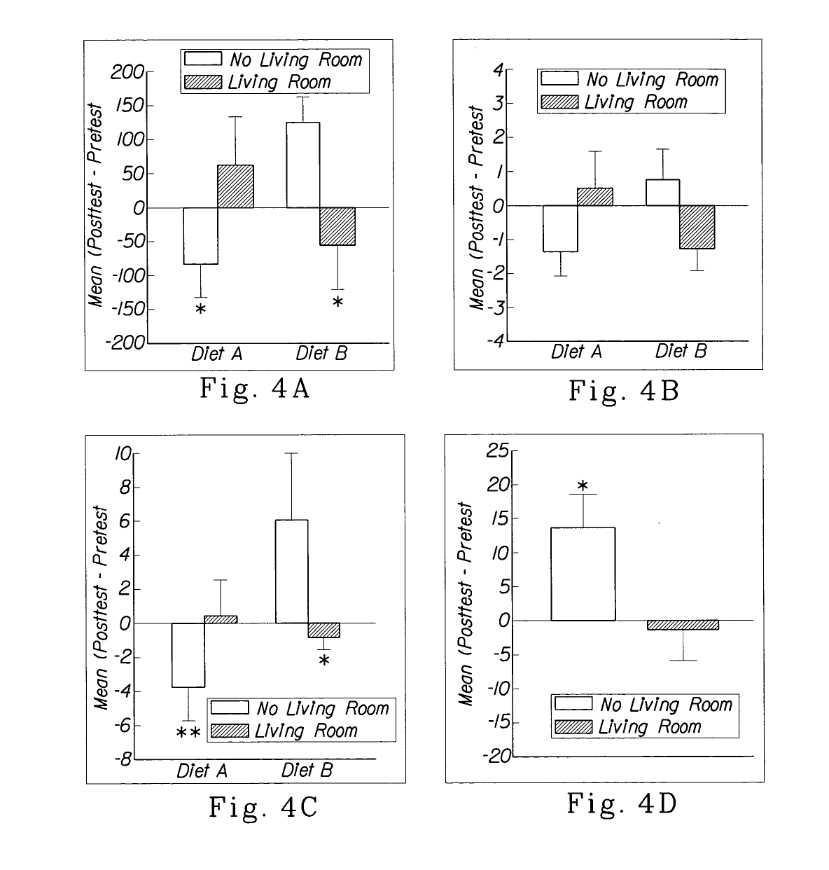

There were several significant effects in the test of responsiveness to the stranger (FIG. 4). Significant No Living Room/Living Room×Diet interactions were obtained for the change from pre-test to post-test in seconds panting, F (1,36)=7.49, p=0.01 and number of yawns, F (1,36)=5.04, p=0.031. For those dogs not exposed to the living room, there was a relative reduction in seconds spent panting from pre-test to post-test if fed Diet A and a relative increase in panting over this time if fed Diet B (p<0.05). This pattern tended to reverse for dogs exposed to the living room. A similar pattern was evident for the number of yawns, though tests for simple main effects were not significant.

These interactions were also assessed by examining how the living room affected behavior within each diet condition. For dogs fed Diet A, there was no significant effect of the living room on seconds spent panting. For dogs fed Diet B, the difference between the relative increase in panting from pre-test to post-test if not exposed to the living room and the relative decrease in panting from pre-test to post-test if exposed to the living room, was significant (p<0.05). For yawns, there again were no significant simple main effects.

Licking of the stranger also showed a similar pattern, though nonparametric tests were required for this measure. These indicated that among dogs not exposed to the living room, there was a relative reduction in licking of the stranger from pre-test to post-test if dogs were fed Diet A and a relative increase in licking of the stranger across this period if fed Diet B (p=0.005). Further, the relative increase in licking the stranger from pre-test to post-test in dogs fed Diet B was eliminated if the dogs had been exposed to the living room manipulation (p=0.015).

For non-directed licking, ANOVA revealed a main effect of No Living Room/Living Room, F (1, 36)=5.21, p=0.029, reflecting a relative increase from pre-test to post-test in non-directed licking among those dogs not exposed to the living room, but not among those dogs exposed to the living room. For seconds in contact with the stranger, the main effect of Diet approached significance, F (1, 36)=3.83, p=0.058. Those dogs fed Diet A showed a relative increase in seconds in contact from pre-test to post-test (M=49.4, se=42.4 s), whereas dogs fed Diet B showed a relative decrease in this measure over the same period (M=−73.1, se=46.0 s).

Analysis of Pre-Test Scores

To ensure that significant effects obtained in analyses of the difference scores computed for the behavioral battery and test of responsiveness to the stranger did not reflect differences in Week 0 pre-test scores, a series of ANOVAs and Mann-Whitney U tests were carried out on pre-test scores for all measures on which difference scores were found to be significant. The only effect of significance was a tendency for fewer total escapes during the pre-test for dogs not exposed to the living room if given Diet B than if given Diet A (p=0.052).

Endocrine Levels

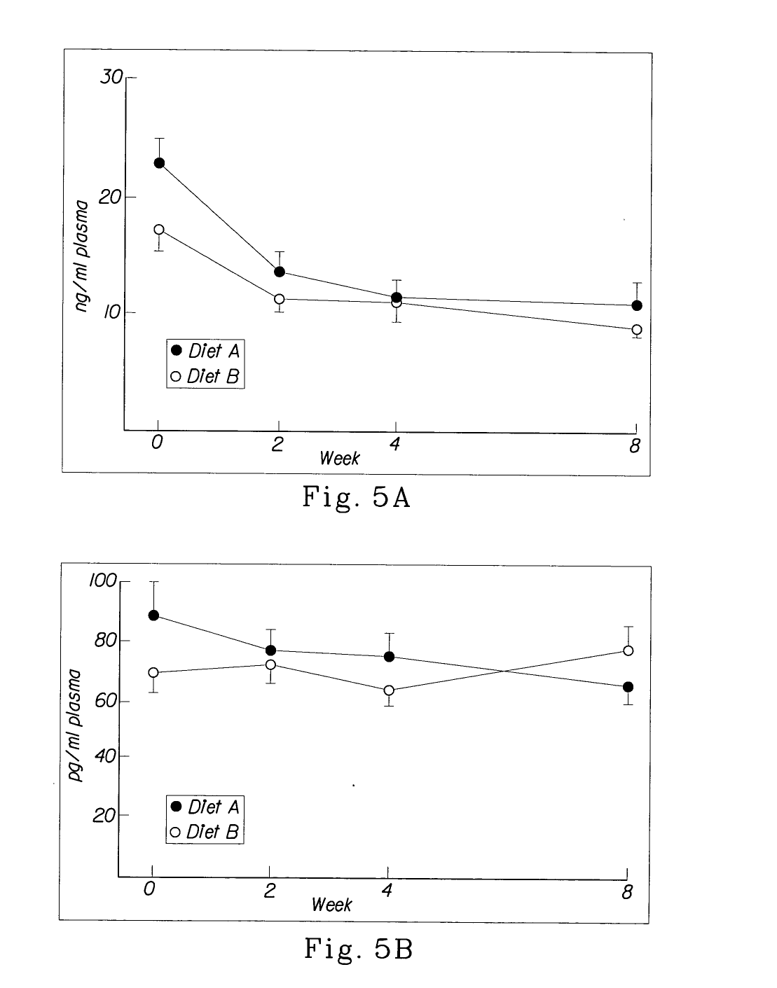

Circulating hormone levels measured at Weeks 0, 2, 4, and 8 (FIG. 5) were assessed in 3-way ANOVAs (No Living Room/Living Room×Diet×Weeks). For cortisol, there was only a significant effect of Weeks, F (3, 108)=19.76, p<0.001. Paired comparisons indicated that cortisol levels at 2, 4, and 8 weeks were lower than at 0 weeks (ps<0.01). The ANOVA for ACTH yielded a significant Diet×Weeks interaction, F (3, 60)=3.87, p<0.05 (with Greenhouse-Geisser correction). Paired comparison tests showed that dogs fed Diet B exhibited a decline in circulating ACTH levels from Week 0 to Week 8 (p<0.05). Paired comparisons showed that dogs fed Diet A had comparable ACTH levels at each of the 4 time points.

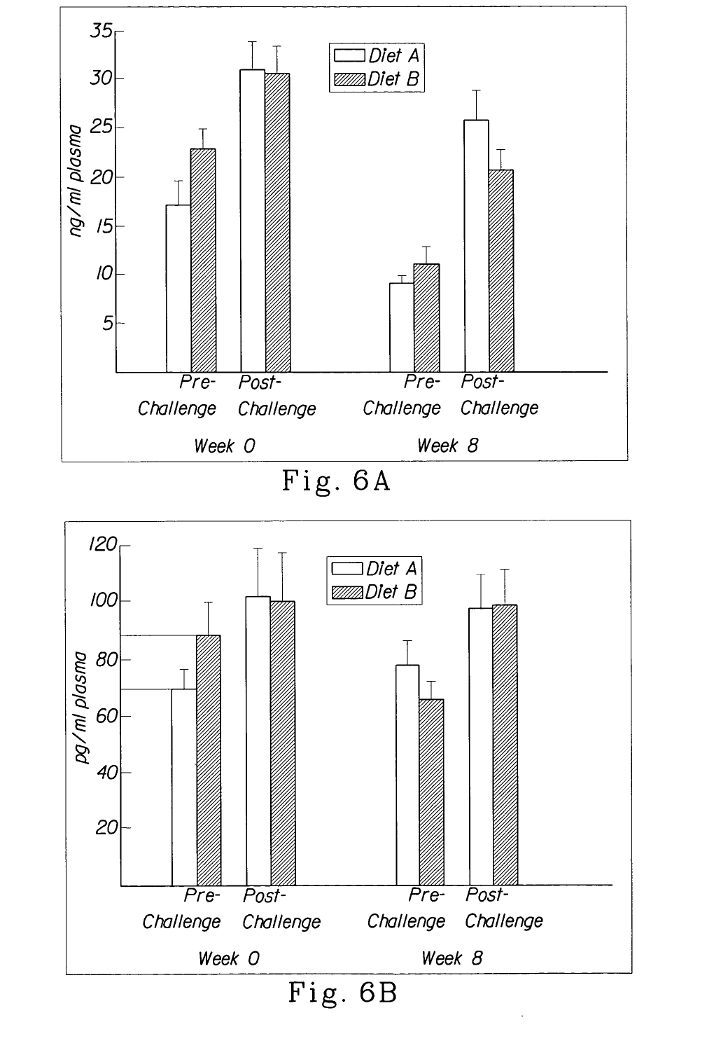

To assess the effect of the challenge on endocrine levels, we compared the values taken at the conclusion of the test battery in the unfamiliar arena with the circulating values obtained just prior to assessment in the battery. Two different approaches were used. First, absolute cortisol and ACTH levels were examined in 4-way ANOVAS (No Living Room/Living Room×Diet×Weeks×Challenge, i.e., before and after the battery) with the last two factors treated as repeated measures. For cortisol, the main effects of Weeks and Challenge were significant (Weeks: F (1, 36)=54.45, p<0.001; Challenge: F (1, 36)=40.32, p<0.001). These effects indicate that overall levels declined from Week 0 to Week 8, and that the challenge elevated plasma cortisol levels. Although FIG. 6 suggests that Diet may have influenced the change in response to the challenge from Week 0 to Week 8, there were only marginally significant effects involving the factor of Diet [Diet×Weeks: F (1, 36)=3.42, p=0.073; Diet×Challenge: F (1, 36)=3.62, p=0.065]. For ACTH, the only significant outcome was a main effect for Challenge, F (1, 20)=13.79, p=0.001, indicating that exposure to the behavioral battery reliably elevated ACTH levels both before and at the conclusion of the intervention period.

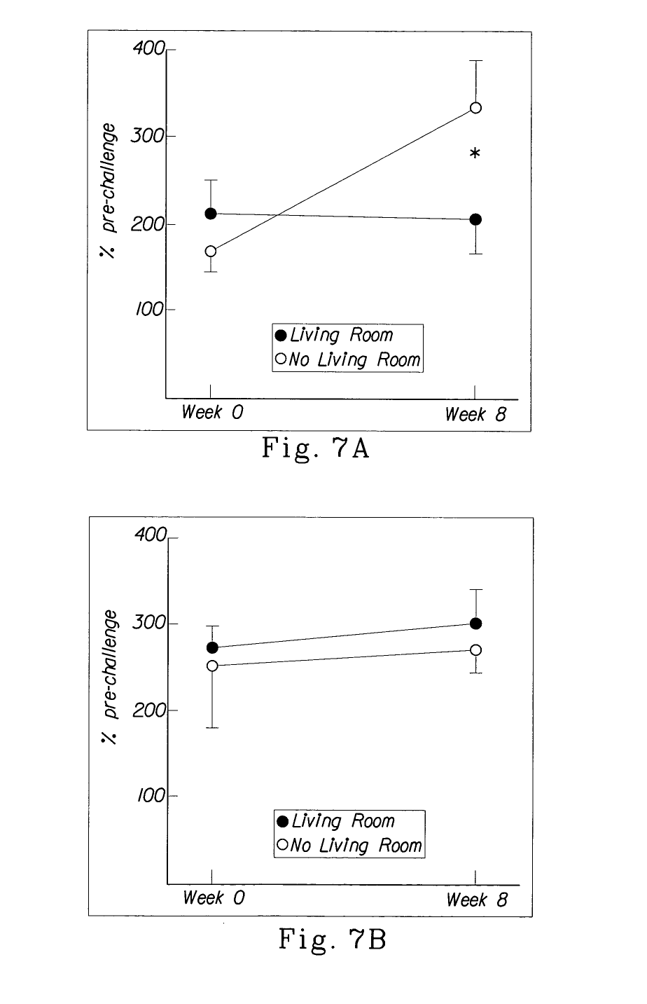

To directly assess cortisol and ACTH responses to challenge while simultaneously accounting for differences in prechallenge activity, we also examined post-challenge levels as a percentage of pre-challenge levels with 3-way ANOVAs (No Living Room/Living Room×Diet×Weeks). For cortisol, the ANOVA revealed significant main effects of Diet, F (1, 36)=6.91, p<0.05 (Diet A>Diet B) and Weeks, F (1, 36)=4.89, p<0.05. The main effect for Weeks was qualified by a significant No Living Room/Living Room×Weeks interaction, F (1, 36)=5.85, p<0.05. As illustrated in FIG. 7, the response to Challenge was almost twice as great at Week 8 than at Week 0 if dogs did not experience the living room during the intervening period (p<0.05). However, there was no change in the magnitude of the cortisol response if dogs had been exposed to the living room from Week 1 to Week 8. For ACTH, there were no significant main or interaction effects.

Finally, to assess whether hormone levels were affected by the time required to collect blood samples, we computed correlation coefficients between sampling time and levels of both cortisol and ACTH across all subjects (40 for cortisol; 24 for ACTH). For this analysis, we chose a priori to examine endocrine levels following challenge at Week 0. These values were well suited for the correlational analysis both because there was appreciable variability among scores, and because there was no significant effect for either the living room or dietary manipulations on either cortisol or ACTH levels. No significant relation between sampling time and endocrine levels was obtained (p>0.10).

Discussion

Human Interaction and Diet

This study found effects of both a program of human interaction and diet on the behavior of dogs confined in a public animal shelter. Line-crossings in the last phase of the behavioral battery were reduced in the post-test relative to the pre-test if the dogs had been fed Diet B, an example high quality diet. This effect did not reflect a greater reduction in activity in response to the airhorn in Phase 4 by dogs fed Diet B: A direct assessment of reduction in line-crossings in Phase 4 relative to Phase 1 was not significant. Rather, it appears that dogs fed Diet B showed a general reduction in activity in the test arena from pre-test to post-test, and this difference reached significance in Phase 4. The marginally significant effects of diet on line-crossings totaled across Phases 1, 3, and 4, and on the factor of Locomotor Activity support this conclusion.

Diet B also reduced the number of escape attempts made during the behavioral battery, but only in dogs that also had been given regular exposure to the living room. In the Response to Stranger Test, we found a main effect of the living room manipulation. Those dogs exposed to this quiet human contact on a regular basis showed fewer instances of the presumed anxious behavior of non-directed licking in the post-test relative to the pre-test than did dogs not given these supplemental periods of human interaction. Together, the results suggest that a high-quality diet, such as Diet B, and a regular, but limited, period of supplemental human interaction can have a calming influence of dogs housed in an animal shelter.

We also found more complex interactive effects on the measures of seconds spent panting (often a sign of anxiety or fear, Voith & Borchelt, 1996), number of yawns (a displacement behavior indicative of conflict, Voith, McGrave, & Marder, 1987), and the number of instances that dogs licked the stranger in the Response to Stranger Test (a measure of solicitation of human contact in a threatening situation). In each case, reactivity in the novel environment tended to be reduced in the post-test relative to the pre-test in dogs not exposed to the living room if they had been fed Diet A, and in dogs exposed to the living room if they had been fed Diet B. The differences were particularly pronounced for those dogs not exposed to the living room.

In an earlier laboratory study, Miller (Miller, Effects of contingent and noncontingent caretaking: differential human social responding to solicitations of young canids. Unpublished master's thesis, The Ohio State University, Columbus (1991); see Tuber et al., Psychol. Sci., Vol. 10, pp. 379-386 (1999)) used a living room procedure to shape social behavior that was judged to be desirable in adopted puppies. Human contact was made contingent upon the emission of solicitation behaviors (e.g., licking, nosing, or pawing the person). Under those conditions, the living room increased later quiet contact with humans in an unfamiliar environment.

In the living room procedure of this study, the human contact provided juvenile/adult dogs was not made contingent on solicitation behavior. Therefore, it is not surprising that the living room did not increase contact, licking of the stranger, or other solicitation behaviors in either behavioral test. Moreover, under the conditions of this study, solicitation behaviors in the test arena seem likely to reflect insecurity in the novel environment, rather than simple attraction to humans.

Previous studies have suggested that heightened levels of dietary protein can promote aggressiveness in some dogs (Dodman et al., J. Am. Vet. Med. Assoc., Vol. 208, pp. 376-379 (1996); DeNapoli et al., J. Am. Vet. Med. Assoc., Vol. 217, pp. 504-508 (2000)). In the present study, any dog that displayed signs of aggression upon admittance to the shelter was not considered suitable for adoption, and therefore was not included in the pool of potential subjects. Among our subjects, frank aggression was never observed in either the behavioral tests or the living room. Among our sample of dogs selected for nonaggressiveness, no suggestion of diet-induced aggression was obtained.

The reduction in non-directed licking by dogs exposed earlier to the living room, and the reduction in escape attempts by dogs both previously exposed to the living room and provided Diet B, demonstrate that the living room can also positively affect the later behavior of dogs in a shelter beyond any change in specific behaviors shaped by the training. Further, the behavioral training affords a means to correct identified behavioral problems and to promote basic skills (e.g., sit-stay) that should ease the dog's transition into an adoptive home. The relatively modest investment of time (20 min/day, 5 days/week) and space (one small room) should make the procedure feasible in some shelters, particularly those with volunteer programs in place.

Diet & Human Interaction on Endocrine Levels

This study also found moderating effects of both diet and a program of human interaction on measures of HPA activity in shelter dogs. Dogs fed Diet B showed a decline in circulating ACTH levels by Week 8, whereas dogs fed Diet A did not. This finding suggests a nutritional influence on adaptation to the shelter environment. This effect was seen only for ACTH. Cortisol levels, which had significantly declined in both diet groups by the 2-week time point, showed no differential effect of diet.

A very different effect was found for the program of human interaction. In those dogs not exposed to the living room procedure, the percent rise in cortisol levels following exposure to the test battery nearly doubled from Week 0 to Week 8. This increase was completely eliminated if dogs experienced a modest amount of regular human interaction in the living room. It seems that continuous housing in the shelter resulted in a sensitization of the endocrine response to the test battery, but that exposure to the living room procedure prevented this sensitization from occurring. An effect of the living room procedure was not seen for ACTH. Because blood was sampled at a single time point after the challenge, the absence of a similar effect for ACTH may have been due to the differing time courses of the ACTH and cortisol responses.

Following exposure to an acute stressor, secretagogues released from the hypothalamus, particularly corticotropin-releasing factor, stimulate the pituitary to release ACTH, which in turn causes the adrenal cortex to secrete glucocorticoids, such as cortisol. Thus, the response of the various hormones of the HPA axis typically is highly correlated, though each follows its own particular time course. During exposure to a chronic stressor, this correlation can be reduced (HPA dysregulation may occur) by, for instance, a gradual reduction in the sensitivity of a gland for its tropic hormone. In earlier work, we observed a protracted cortisol response by dogs upon admittance to the shelter: levels were elevated during their first 3 days, and appeared to show a gradual decline thereafter (Hennessy et al., Physiol. Behav., Vol. 62, pp. 485-490 (1997)). In agreement, the present study found that cortisol levels on Day 3 had declined by the next measurement on Day 19. However, ACTH levels, which we had not measured previously, showed no significant change over this same period.

In a recent study examining possible predictors of behavior in dogs adopted from a shelter, we were surprised to find that relatively low cortisol levels on the second day in the shelter were associated with greater owner reported behavioral problems 6 months following adoption (Hennessy et al., 2001). It was hypothesized that lower cortisol levels in these dogs might reflect, not diminished stress in response to confinement in the shelter, but rather dysregulation of the HPA axis as a result of exposure to stressors prior to admittance to the shelter. For instance, dogs experiencing chronic stress due to neglect or abandonment might exhibit reduced sensitivity of the adrenal in response to chronic elevations of ACTH. If so, admittance to the shelter might produce a smaller elevation in plasma cortisol levels in these dogs than in dogs not undergoing continuous exposure to stressors prior to admittance, even if both groups of dogs secreted equivalent amounts of ACTH. The finding in the present study that plasma cortisol levels showed a clear drop by the 2 week time point, but plasma ACTH levels did not, is relevant because it suggests that dogs may indeed show reduced adrenal sensitivity in response to continuous psychological stress and secretion of ACTH.

With the venipuncture procedure employed, all blood samples were collected within 4 minutes, and usually much faster. Findings in rats and mice indicate that this is rapid enough to ensure the blood sampling procedure itself did not affect concentrations of cortisol in the samples collected (Coover et al., Physiol. Behav., Vol. 6, pp. 261-263 (1971); Davidson et al., Endocrinol., Vol. 82, pp. 655-663 (1968); Riley et al., Psychoneuroimmunology, Academic Press, pp. 31-102 (1981)). Plasma ACTH levels elevate more rapidly to stimulation than do cortisol levels, so that levels of ACTH obtained probably were influenced to some degree by the sampling procedure. However, the lack of a significant correlation between ACTH levels and sampling time indicates that any such effect of sampling that did occur was not powerful. Further, it is clear that the ACTH measure still reflected the experimental manipulations, as indicated by both the effect of diet as well as the post-challenge increase observed in ACTH levels.

Earlier, it was demonstrated that human interaction involving soothing petting could moderate the cortisol response to the mild stressor of venipuncture in shelter dogs when the petting immediately followed stressor exposure. The present findings extend these results in two ways. First, they show that a program of human interaction at a time remote from an acute psychological stressor can reduce cortisol responses. Second, the findings suggest that a nutritional intervention can independently reduce the ACTH response to shelter housing.

All percentages and ratios are calculated by weight unless otherwise indicated. All percentages and ratios are calculated based on the total diet unless otherwise indicated.

Referenced herein are trade names for components including various ingredients utilized in the present invention. We do not intend to be limited by materials under a certain trade name. Equivalent materials (e.g., those obtained from a different source under a different name or reference number) to those referenced by trade name may be substituted and utilized in the descriptions herein.

In the description of the invention various embodiments and/or individual features are disclosed. As will be apparent to the ordinarily skilled practitioner, all combinations of such embodiments and features are possible and can result in preferred executions of the present invention.

The diets herein may comprise, consist essentially of, or consist of any of the elements as described herein.

While various embodiments and individual features of the present invention have been illustrated and described, various other changes and modifications can be made without departing from the spirit and scope of the invention. As will also be apparent, all combinations of the embodiments and features taught in the foregoing disclosure are possible and can result in preferred executions of the invention.

All publications, patents, and patent documents are incorporated by reference herein, as though individually incorporated by reference. The invention has been described with reference to various specific and preferred embodiments and techniques. However, it should be understood that many variations are modifications may be made while remaining within the spirit and scope of the invention.

What is claimed is:

1. A method selected from the group consisting of improving the adaptation of a dog to an animal shelter, moderating the behavior of a dog living in an animal shelter, increasing the rate of successful adoption of a dog from an animal shelter, decreasing anxiety in a dog, increasing the welfare of a dog, and combinations thereof comprising feeding the dog a high quality diet.

2. The method according to claim 1 wherein ACTH levels in the dog are decreased.

3. The method according to claim 1 wherein cortisol levels in the dog are decreased.

4. The method according to claim 1 wherein HPA levels are decreased.

5. The method according to claim 1 wherein the high quality diet is a dry diet comprising from about 5% to about 50% crude protein, from about 0.5% to about 25% crude fat, from about 1% to about 10% crude fiber, and from about 1% to about 30% moisture, all by weight of the diet.

6. The method according to claim 5 wherein the high quality diet comprises at least about 0.05% DHA and at least about 0.05% EPA, all by weight of the diet.

7. The method according to claim 6 wherein the high quality diet comprises at least about 0.1% DHA and at least about 0.1% EPA, all by weight of the diet.

8. The method according to claim 7 wherein the high quality diet comprises from about 15% to about 35% crude protein, from about 10% to about 25% crude fat, from about 1% to about 5% crude fiber, and from about 5% to about 20% moisture, all by weight of the diet.

9. The method according to claim 8 wherein the high quality diet has a minimum metabolizable energy level of about 3.5 Kcal/g.

10. The method according to claim 9 wherein the high quality diet comprises from about 20% to about 50% of animal-derived ingredients, by weight of the diet.

11. The method according to claim 10 wherein the high quality diet comprises from about 35% to about 50% of animal-derived ingredients, by weight of the diet.

12. The method according to claim 10 wherein the high quality diet comprises at least about 0.15% DHA and at least about 0.15% EPA, all by weight of the diet.

13. The method according to claim 1 wherein the high quality diet is a moist diet comprising from about 0.5% to about 40% crude protein, from about 0.5% to about 25% crude fat, from about 0.5% to about 15% crude fiber, from about 60% to about 90% moisture, from about 0.1% to about 20% ash, and from about 0.001% to about 5.0% taurine, all by weight of the diet.

14. The method according to claim 13 wherein the high quality diet comprises at least about 0.05% DHA and at least about 0.05% EPA, all by weight of the diet.

15. The method according to claim 14 wherein the high quality diet comprises at least about 0.1% DHA and at least about 0.1% EPA, all by weight of the diet.

17. The method according to claim 16 wherein the high quality diet has a minimum metabolizable energy level of about 3.5 Kcal/g.

18. A method selected from the group consisting of decreasing ACTH levels in a dog, decreasing cortisol levels in a dog, decreasing HPA levels in a dog, and combinations thereof, comprising feeding the dog a high quality diet.

19. The method according to claim 18 wherein the high quality diet is a dry diet comprising from about 5% to about 50% crude protein, from about 0.5% to about 25% crude fat, from about 1% to about 10% crude fiber, and from about 1% to about 30% moisture, all by weight of the diet.

20. The method according to claim 19 wherein the high quality diet comprises at least about 0.05% DHA and at least about 0.05% EPA, all by weight of the diet.

21. The method according to claim 20 wherein the high quality diet comprises at least about 0.1% DHA and at least about 0.1% EPA, all by weight of the diet.

22. The method according to claim 21 wherein the high quality diet comprises from about 15% to about 35% crude protein, from about 10% to about 25% crude fat, from about 1% to about 5% crude fiber, and from about 5% to about 20% moisture, all by weight of the diet.

23. The method according to claim 22 wherein the high quality diet has a minimum metabolizable energy level of about 3.5 Kcal/g.

24. The method according to claim 23 wherein the high quality diet comprises from about 20% to about 50% of animal-derived ingredients, by weight of the diet.

25. The method according to claim 24 wherein the high quality diet comprises from about 35% to about 50% of animal-derived ingredients, by weight of the diet.

26. The method according to claim 24 wherein the high quality diet comprises at least about 0.15% DHA and at least about 0.15% EPA, all by weight of the diet.

27. The method according to claim 18 wherein the high quality diet is a moist diet comprising from about 0.5% to about 40% crude protein, from about 0.5% to about 25% crude fat, from about 0.5% to about 15% crude fiber, from about 60% to about 90% moisture, from about 0.1% to about 20% ash, and from about 0.001% to about 5.0% taurine, all by weight of the diet.

28. The method according to claim 27 wherein the high quality diet comprises at least about 0.05% DHA and at least about 0.05% EPA, all by weight of the diet.

29. The method according to claim 28 wherein the high quality diet comprises at least about 0.1% DHA and at least about 0.1% EPA, all by weight of the diet.

30. The method according to claim 16 wherein the high quality diet has a minimum metabolizable energy level of about 3.5 Kcal/g.
